(19) United States
(12) Patent Application Publication
(10) Pub. No.: US 2006/0277994 A1
(43) Pub. Date: Dec. 14, 2006

(54) INVERTIBLE MEASURING CUP

(75) Inventor: Sarah S. Peterson, Seattle, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORP., Kent, WA (US)

(21) Appl. No.: 11/423,585

(22) Filed: Jun. 12, 2006

Related U.S. Application Data
(60) Provisional application No. 60/689,608, filed on Jun. 10, 2005.

(51) Int. Cl. G01F 19/00

(52) U.S. Cl. 73/426

(57) ABSTRACT

A measuring cup includes a cup portion formed of a flexible material, such as silicone, secured to a rigid annular portion maintaining the shape of the opening of the cup. A handle secures to the annular portion. A tab may secure to the annular portion opposite the handle. A downwardly extending ridge secures to the annular portion and the cup portion includes a slit circumscribing the opening that receives the ridge.

### PRIORITY CLAIM

This application claims the benefit of prior U.S. Provisional Application Ser. No. 60/689,608, filed Jun. 10, 2005.

### FIELD OF THE INVENTION

This invention relates generally to cooking tools and, more particularly, to measuring cups.

### BACKGROUND OF THE INVENTION

While cooking, one is often called upon to measure ingredients that tend to adhere to the spoon or cup used to scoop or measure the ingredient. For example, chopped vegetables and herbs, shortening, and viscous liquids all tend to stick in large amounts to any implement used to handle them. Accordingly, it may be difficult to measure such ingredients, inasmuch as a significant amount of the ingredient is left in the measuring cup. In order to correct this problem the user must take additional steps to scrape the measuring cup.

In view of the foregoing, it would be an advancement in the art to provide a measuring cup facilitating removal of such ingredients. Such a measuring cup should be easy to use and manufacture.

### SUMMARY OF THE INVENTION

The present invention provides a measuring cup having an invertible cup portion. The cup portion typically secures to a rigid annular portion maintaining the shape of the opening of the cup. A narrow ridge extending around the annular portion may be received within a slit formed in the cup to secure the cup to the annular portion.

A handle secures to the annular portion and may be formed integrally therewith. A tab may also secure to the annular portion opposite the handle to facilitate inversion of the cup. In one embodiment, the cup is formed of a flexible material such as silicone, rubber, or flexible plastic. The flexible material may have sufficient thickness to maintain its shape despite the application of some deformative force. For example, it may resist stretching while being filled in order to provide accurate measurement. In other embodiments, a somewhat rigid yet bendable material may be used.

### BRIEF DESCRIPTION OF THE DRAWINGS

Preferred and alternative embodiments of the present invention are described in detail below with reference to the following drawings.

FIG. 1 is a perspective view of an invertible measuring cup, in accordance with one embodiment of the present invention;

FIG. 2 is a side cross-sectional view of an invertible measuring cup, in accordance with one embodiment of the present invention;

FIG. 3 is perspective view of the invertible cup of FIGS. 1 and 2 in an inverted position, in accordance with one embodiment of the present invention; and

FIG. 4 is a perspective view of a number of invertible cups in a nested arrangement, in accordance with one embodiment of the present invention.

### DETAILED DESCRIPTION OF THE PREFERRED EMBODIMENT

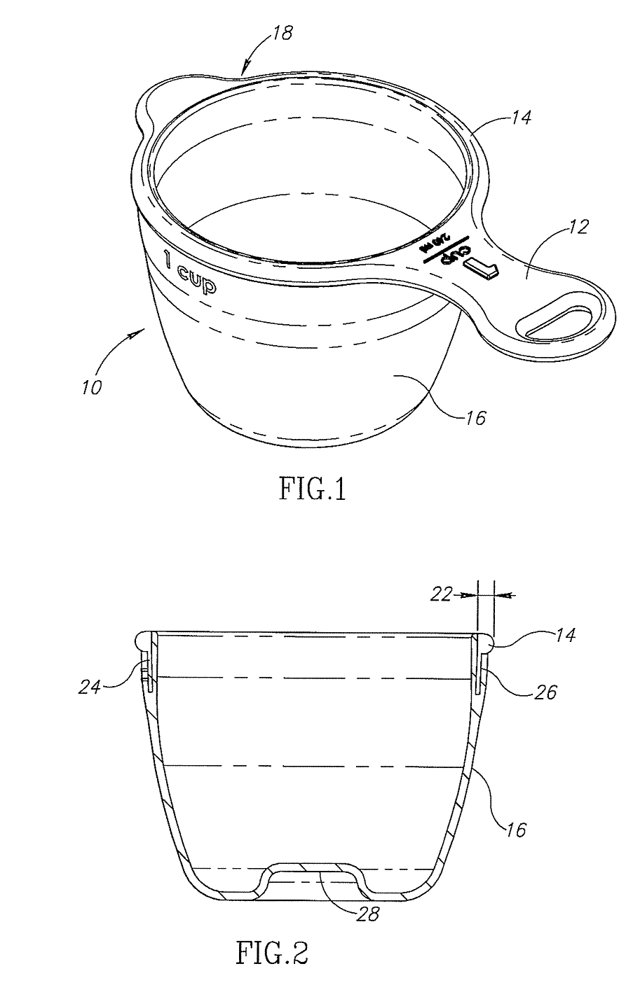

Referring to FIG. 1, in one embodiment, an invertible cup 10 includes a handle 12, rim 14, and a cup 16. The handle 12 couples to the rim 14 near an opening 18 of the cup 16. The handle 12 provides a member for gripping by a user when filling and emptying the cup 16. The handle 12 secures to the rim 14, which surrounds the opening 18 of the cup 16. The rim 14 may be formed of a rigid material and serves to maintain the shape of the opening 18 of the cup 16. The rim 14 may also provide a rigid leading edge for facilitating scooping functions of the cup 10. In the illustrated embodiment, the rim 14 and handle 12 are integrally or monolithically formed. In some embodiments, the rim 14 and cup 16 are integrally formed. In such embodiments, the rim 14 is preferably rigid or semi-rigid notwithstanding its formation of a flexible material, for example by forming the rim from a thicker section of material than that used for the cup or by including an internal stiffener made from rigid plastic, metal, or other materials. The handle 12 may likewise be formed integrally with the cup portion 16 and yet be formed to be somewhat rigid.

The cup portion 16 defines a volume for containing ingredients and is typically formed of a substantially flexible material. In the illustrated embodiment, the cup portion 16 is formed of silicone, however natural and synthetic rubbers, flexible plastic, and the like may also be used. Silicone may provide the advantage of being flexible and resistant to high temperatures.

Referring to FIG. 2, the rim 14 typically has a thickness 22 greater than that of the cup portion 16 due to the requirement of rigidity. A securement ridge 24 may extend downwardly from the annular portion 14 and provide a surface area for adhering the cup portion 16 to the annular portion 14. A slit 26 circumscribes the upper edge of the cup portion 16 and receives the securement ridge 24. In the preferred form, the cup is over-molded onto the ridge. An adhesive may be used to secure the slit 26 to the securement ridge 24 as another means for securing the cup to the ridge. Alternatively, the securement ridge 24 may be made slightly larger than the slit 26 such that insertion of the securement ridge 24 slightly deforms the slit 26, resulting in a frictional restoring force that maintains the securement ridge 24 within the slit 26. In other embodiments, the slit 26 is omitted and the inner or outer surface of the cup 16 is adhered to the securement ridge 24. In the illustrated embodiment, the cup 16 extends upwardly such that an upper rim of the cup is substantially flush with the uppermost portion of the rim 16. Such a configuration may provide for a continuous sealed volume for containing liquid ingredients. A concavity (viewed from the bottom of the cup) or inset portion 28 may be formed near the lowermost portion of the cup 16. The inset portion 28 may provide a tactile indication to a user of where to apply pressure when inverting the cup 16 as well as improve the rigidity of the bottom of the cup 16.

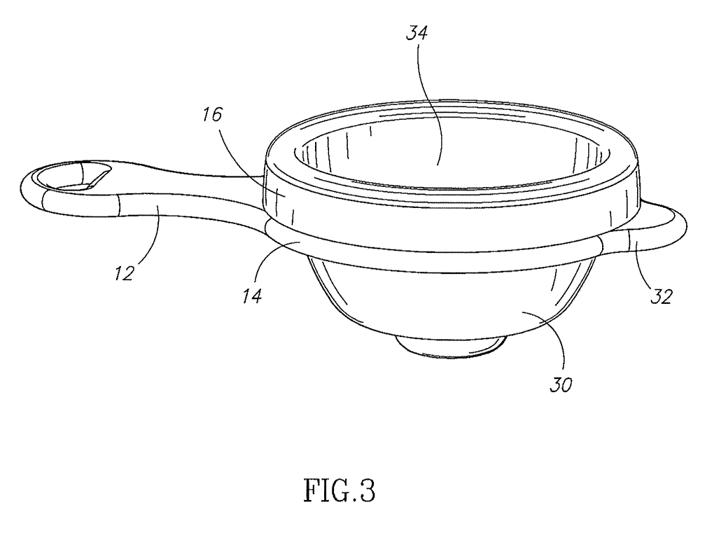

Referring to FIG. 3, in operation the cup portion 16 is typically filled with an ingredient, such as chopped vegetables or herbs, shortening, or viscous liquids such as molasses. The cup portion 16 is then inverted. In the illustrated embodiment, a substantial portion of the cup portion 16 passes through the rim 14. In the case of semi solid and gelatinous ingredients, inversion may result in a substantially contiguous mass being forced out of the cup portion 16. For other, less cohesive ingredients, the increase of the surface area of the inner surface 30 of the cup portion 16 tends to loosen the adhesion between the cup portion 16 and the ingredient, facilitating emptying of the cup portion 16. In the case of ingredients that nonetheless adhere to the cup portion 16, inversion provides a convenient surface for removing the ingredients from the cup portion 16. For example, a typical user of a prior measuring cup might scrape ingredients from the cup using a spoon or scraper and then scrape the spoon or scraper across the edge of a mixing bowl or the like. In one method of use of the present invention, the inner surface 30 of the cup portion 16 when inverted may be directly scraped against the side of a mixing bowl or the like without the need for an additional step or use of an additional utensil. Inversion of the cup portion 16 may also facilitate cleaning of the inner surface 30.

Inversion may be accomplished by supporting the annular portion 14 and pressing on the lowermost portion of the cup portion 16. In the illustrated embodiment, a tab 32 is secured to the annular portion 14 opposite the handle 12. A user may support the tab 32 and handle 12 with the fingers and push with the thumbs on the outer surface 34 of the cup portion 16 to invert the cup portion 16.

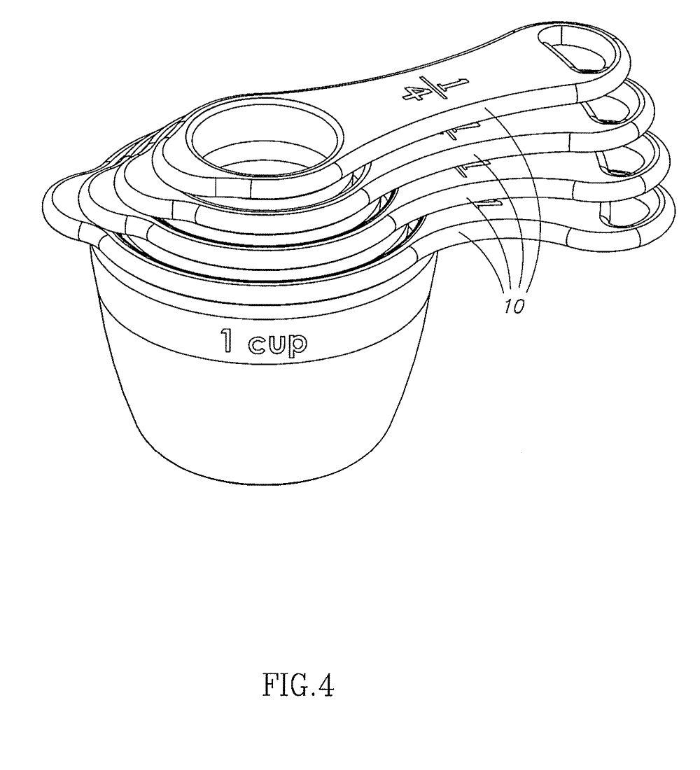

Referring to FIG. 4, the cup 10 may be nested with other cups 10 to provide for a range of measurement sizes. As is apparent in FIG. 4, the cups 10 bear indicia one or both of the cup portion 16 and the handle 12 indicating the volume of the cup portion 16.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A cup comprising:
an annular portion comprised of a rigid material; and
a cup portion comprised of a substantially flexible material secured proximate an opening thereof to the annular portion.

2. The cup of claim 1, further comprising a downwardly extending ridge secured to the annular portion and wherein the cup portion comprises a slit circumscribing the opening, the ridge positioned within the slit.

3. The cup of claim 2, wherein an inner portion of the cup portion proximate the ridge extends upwardly to proximate an upper surface of the annular portion and wherein an outer portion of the cup portion proximate the ridge abuts a lower surface of the annular portion.

4. The cup of claim 1, wherein the cup portion bears indicia indicating the volume of the cup portion.

5. The cup of claim 1, further comprising a handle rigidly secured to the annular portion.

6. The cup of claim 5, further comprising a tab projecting outwardly from the annular portion and secured to the annular portion opposite the handle.

7. A method for measuring comprising:
providing a flexible cup having a predetermined volume;
depositing a quantity of a substance in the flexible cup; and
inventing at least a portion of the cup to remove the substance.

8. The method of claim 7, wherein the cup further comprises a rigid annular portion secured to the cup adjacent a rim of the cup.

9. The method of claim 7, wherein the cup bears an indicia indicating the volume of the cup portion.

10. The method of claim 7, wherein a handle rigidly secures to the cup.

11. The method of claim 8, wherein a spout is formed on the annular portion and projects outwardly from the cup.

12. The method of claim 11, wherein the cup has a top and a bottom, the method further comprising turning over the cup and urging a substantial portion of the bottom of the cup through the annular portion.

13. An invertible cup comprising:
a substantially circular ring including a rigid material and having a ridge secured thereto and extending downwardly therefrom, the ridge having a radial thickness substantially less than that of the circular ring; and
a cup defining an opening, the cup formed of a material substantially more flexible than the rigid material, the cup further defining a slit circumscribing the opening the ridge being positioned within the slit.

14. The invertible cup of claim 14, wherein an inner portion of the cup located proximate the ridge extends upwardly to proximate an upper surface of the ring and wherein an outer portion of the cup located proximate the ridge abuts a lower surface of the ring.
